(19) United States
(12) Patent Application Publication
(10) Pub. No.: US 2010/0000879 A1
(43) Pub. Date: Jan. 7, 2010

(54) ELECTROCHEMICAL NOISE AS A LOCALIZED CORROSION INDICATOR

(75) Inventors: Karel Hladky, Fallowfield (GB); Roolf Wessels, Chagrin Falls, OH (US)

Correspondence Address: FAY SHARPE LLP, 1228 Euclid Avenue, 5th Floor, The Halle Building, Cleveland, OH, 44115, US

(73) Assignee: Pepperl+Fuchs, Inc., Twinsburg, OH (US)

(21) Appl. No.: 12/494,519

(22) Filed: Jun. 30, 2009

Related U.S. Application Data
(60) Provisional application No. 61/077,551, filed on Jul. 2, 2008.

(51) Int. Cl. G01N 17/02; G01N 27/26

(52) U.S. Cl. 205/775.5; 204/404

(57) ABSTRACT

Systems and methods are presented for a method for measuring or monitoring localized corrosion in which an electrochemical noise (ECN) signal is sensed and filtered by a high-pass or band-pass filter to remove low frequency components not related to localized corrosion and a standard deviation of the filtered signal is computed and scaled to provide a localized corrosion value.

### REFERENCE TO RELATED APPLICATIONS

This application claims priority to and the benefit of U.S. Provisional Patent Application Ser. No. 61/077,551, filed Jul. 2, 2008, entitled “ELECTROCHEMICAL NOISE AS A LOCALISED CORROSION INDICATOR”, the entirety of which is hereby incorporated by reference.

This application is related to U.S. Pat. No. 7,282,928, filed Jul. 13, 2006, entitled “CORROSION MEASUREMENT FIELD DEVICE WITH IMPROVED LPF, HDA, AND ECN CAPABILITY”; U.S. Pat. No. 7,265,559, filed Jul. 13, 2006, entitled “SELF-CALIBRATING CORROSION MEASUREMENT FIELD DEVICE WITH IMPROVED SIGNAL MEASUREMENT AND EXCITATION CIRCUITRY”; U.S. Pat. No. 7,239,156, filed Jul. 13, 2006, entitled “CONFIGURABLE CORROSION MEASUREMENT FIELD DEVICE”; and U.S. Pat. No. 7,245,132, filed Jul. 12, 2006, entitled “INTRINSICALLY SAFE CORROSION MEASUREMENT AND HISTORY LOGGING FIELD DEVICE”, the entireties of which are hereby incorporated by reference.

### TECHNICAL FIELD

The present disclosure relates generally to corrosion measurement and more particularly to systems and methods for electrochemical noise measurement for detecting localized corrosion.

### BACKGROUND

Electrochemical noise (ECN) is a technique for detecting localized corrosion phenomena such as pitting attack, crevice corrosion, stress corrosion cracking, etc. The ECN approach involves measuring fluctuations of the free corrosion potential of a corroding electrode (potential noise) or measurement of the coupling current and its fluctuations between a pair of nominally identical corroding electrodes (current noise). Statistical properties of the measured fluctuations are then analyzed to provide a qualitative measure of the degree of localized corrosion occurring on the test electrodes. Commonly statistical parameters such as standard deviation, skewness or kurtosis of the recorded noise signal are computed and used in an empirical formula to derive a single parameter, referred to as a localized corrosion index or pitting factor that indicates the propensity of the test electrodes to localized corrosion attack. Another approach involves analyzing the electrochemical noise fluctuations in the frequency domain and using parameters such as the roll-off slope of the spectral density plot as a localized corrosion indicator. However, none of the existing approaches have proved to be reliable enough in practice to give a clear indication to the operator of the monitored system or plant whether localized corrosion attack is present. Instead, a degree of expertise is required in order to interpret the variation of the recorded localized corrosion parameter with time to assess whether a particular behavior of this parameter indicates that localized corrosion is occurring. Accordingly, a need remains for improved localized corrosion measurement systems and techniques.

### SUMMARY

Various aspects of the present disclosure are now summarized to facilitate a basic understanding of the disclosure, wherein this summary is not an extensive overview of the disclosure, and is intended neither to identify certain elements of the disclosure, nor to delineate the scope thereof. Instead, the primary purpose of this summary is to present some concepts of the disclosure in a simplified form prior to the more detailed description that is presented hereinafter. The disclosure relates to corrosion measurement systems and techniques that can be employed in field or lab situations to better quantify localized corrosion phenomena.

In accordance with one or more aspects of the disclosure, a corrosion measurement system is provided for measuring or monitoring localized corrosion of a structure exposed to an electrolyte. The system includes a probe interface having signal conditioning and sensing circuitry to interface with measurement electrodes and to sense corrosion-related signals. The system also includes a filter that removes low-frequency components from the sensed corrosion-related signals, as well as a processing system that computes a standard deviation value at least partially according to the filtered corrosion signals. The processing system may then scale the standard deviation to provide a localized corrosion value having a value from 0 to 1 to quantify the severity of the localized corrosion attack. In certain embodiments, the filter is a high-pass filter or a band-pass filter that removes low-frequency components of about 0.05 Hz or less from the sensed corrosion-related signals. The filtering may be performed in digital form, with an analog-to-digital converter providing a digital representation of the sensed corrosion-related signals and the sampled values being provided to a digital high-pass or band-pass filter to remove at least some low-frequency components of the sample stream. Methods are provided for measuring or monitoring localized corrosion, including sensing an ECN signal in the system, filtering the sensed ECN signal to remove low frequency components to generate a filtered ECN signal, computing a standard deviation of the filtered ECN signal, and scaling the standard deviation to provide a localized corrosion index value. Certain embodiments of the method may include storing the localized corrosion value for later retrieval by a user.

### BRIEF DESCRIPTION OF THE DRAWINGS

The following description and drawings set forth certain illustrative implementations of the disclosure in detail, which are indicative of several exemplary ways in which the various principles of the disclosure may be carried out. The illustrated examples, however, are not exhaustive of the many possible embodiments of the disclosure. Other objects, advantages and novel features of the disclosure will be set forth in the following detailed description of the disclosure when considered in conjunction with the drawings, in which:

FIG. 1A is a simplified schematic diagram illustrating an exemplary localized corrosion measurement system in accordance with one or more aspects of the present disclosure;

FIG. 1B is a flow diagram illustrating an exemplary method for measuring or monitoring localized corrosion of a structure exposed to an electrolyte in accordance with further aspects of the present disclosure;

FIG. 1C is a graph illustrating a sensed ECN value over time in an exemplary situation with little or no localized corrosion and hence no low or high frequency noise;

FIG. 1D is a graph illustrating a sensed ECN value over time in an exemplary situation with little or no localized corrosion where a significant amount of low frequency noise is measured but higher frequency noise is absent;

FIG. 1E is a graph illustrating a sensed ECN value over time in an exemplary situation where localized corrosion is occurring and higher frequency noise is apparent;

FIG. 2A is a perspective view illustrating an exemplary corrosion measurement device including a loop or battery powered transmitter with an associated probe and electrodes in accordance with one or more aspects of the present disclosure;

FIG. 2B is a schematic diagram illustrating further details of the transmitter of FIG. 2A including a digital system, a loop interface, and a probe interface;

FIG. 3A is a schematic diagram illustrating portions of the probe interface system and the digital system in the exemplary transmitter of FIGS. 2A and 2B including processor controlled excitation circuitry, sensing circuitry, and an analog switching system for programmatic reconfiguration of the device for a variety of different corrosion measurements;

FIG. 3B is a schematic diagram illustrating further details of the isolation circuitry in the loop interface system of the exemplary transmitter of FIGS. 2A and 2B including an isolation transformer and a two stage intrinsic safety barrier;

FIG. 4 illustrates a table showing several exemplary switching system configurations for SRM, HDA, LPR, cell offset voltage, and ECN measurements in the device of FIGS. 2A-3B;

FIG. 5 is a partial sectional side elevation view schematically illustrating the probe and electrodes of the measurement device installed in a pipe or storage structure with the electrodes exposed to a transported or stored electrolyte for corrosion measurement;

FIG. 6 is a simplified schematic diagram illustrating an equivalent circuit for one of the electrodes and the measured electrolyte in the installation of FIG. 5;

FIG. 7 is a graph illustrating exemplary excitation waveforms applied to the measured electrolyte by the excitation circuitry in a full measurement cycle of the device of FIGS. 2A-6 including an exemplary substantially dc-free 200 Hz bipolar square wave for electrolyte resistance measurement, a 0.1 Hz sine wave for HDA and LPR measurements and an ECN portion with no excitation;

FIG. 8 is a graph further illustrating the substantially dc-free bipolar square wave excitation signal used in the device for electrolyte resistance measurements;

FIG. 9A is a flow diagram illustrating exemplary operation for electrolyte (solution) resistance measurement (SRM) using dynamic excitation amplitude adjustment in the device of FIGS. 2A-6;

FIGS. 9B-9D are graphs showing voltage and current plots of bipolar square wave excitation voltages and corresponding measured average currents for different excitation waveform amplitudes during dynamic amplitude adjustment in the device of FIGS. 2A-6;

FIG. 10A is a graph showing a plot of an exemplary bipolar square wave voltage excitation signal applied at about 200 Hz and two exemplary asynchronous A/D converter samples using a low sample period of about 0.3 second;

FIG. 10B is a graph showing excitation voltage and sensed current plots at the two exemplary sample times in FIG. 10A;

FIG. 10C is a flow diagram illustrating exemplary operation for online current amplifier offset measurement in the device of FIGS. 2A-6;

FIG. 11 is a flow diagram illustrating operation of the device for dynamic algorithm change for HDA or LPR measurement including plausibility testing of a computed B value in the device of FIGS. 2A-6; and

FIG. 12 is a flow diagram illustrating exemplary offset measurement and excitation signal adjustment for HDA corrosion measurement in the device of FIGS. 2A-6.

### DETAILED DESCRIPTION

Referring now to the figures, several embodiments or implementations of the present disclosure are hereinafter described in conjunction with the drawings, wherein like reference numerals are used to refer to like elements throughout, and wherein the various features and plots are not necessarily drawn to scale. The disclosure relates to programmable low power corrosion measurement field devices for providing corrosion measurement and monitoring using one or more advanced corrosion measurement types to provide conductance, general corrosion, and/or localized corrosion values for real time corrosion monitoring and/or off-line corrosion data logging which may be employed in distributed control systems connected by a standard 4-20 mA control loop or other communicative means, or which may act as stand-alone devices with the capability of downloading stored corrosion data to a user communications device, a USB memory stick, micro SD card, etc.

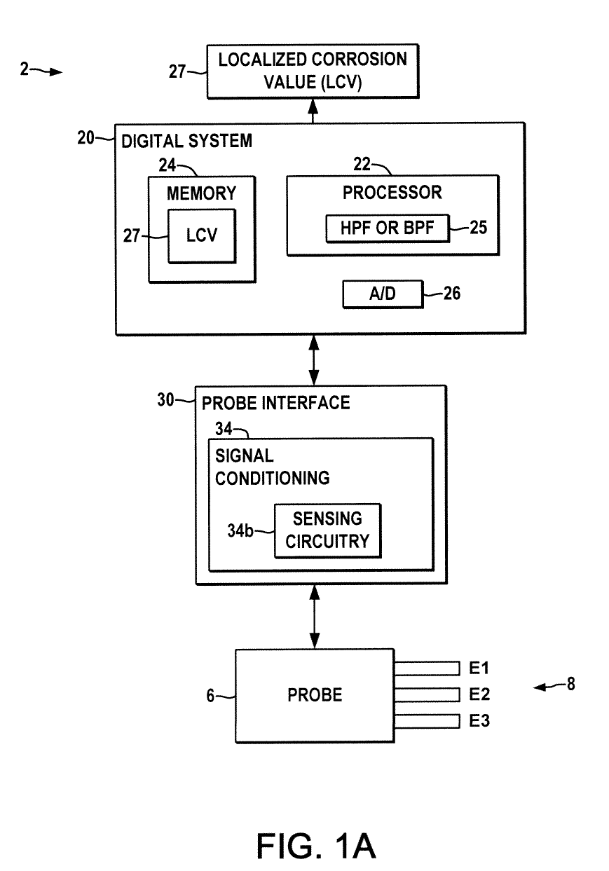

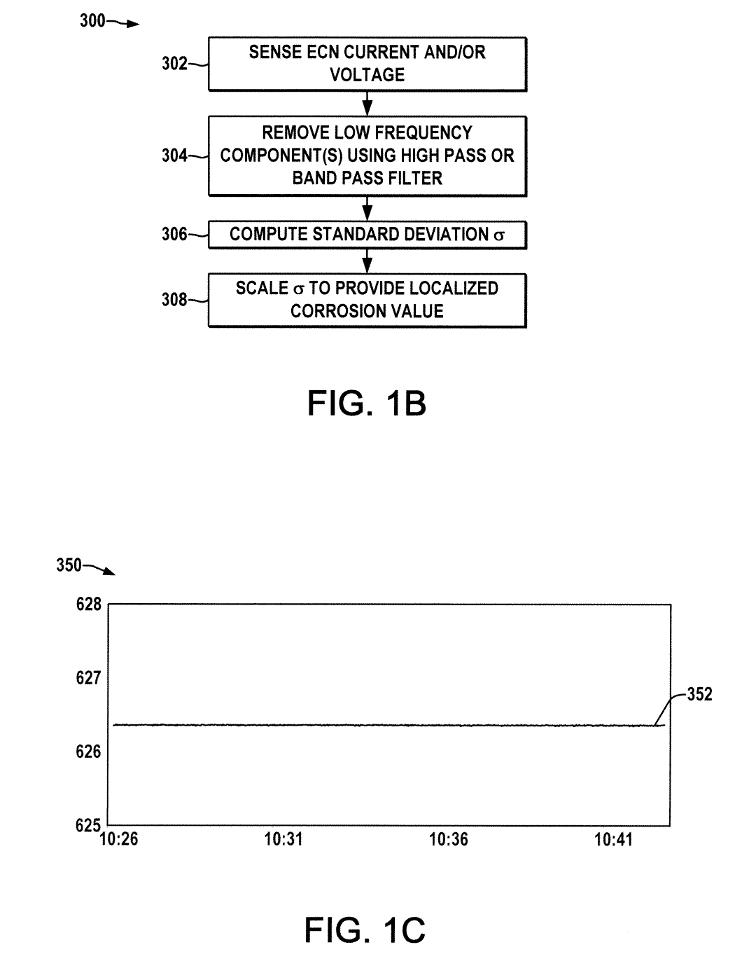

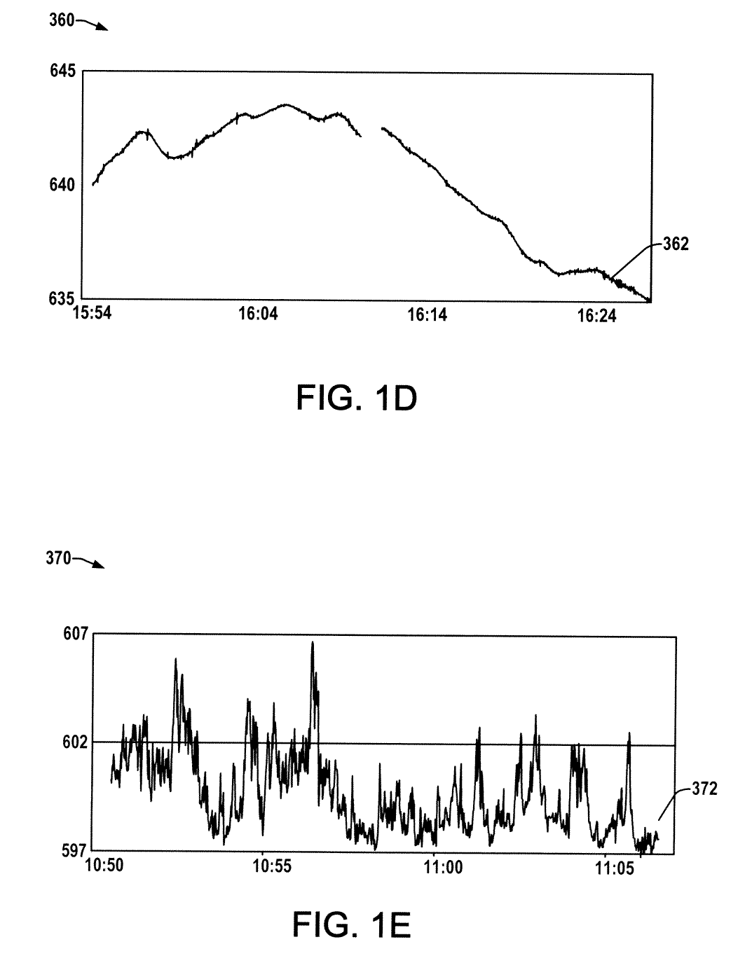

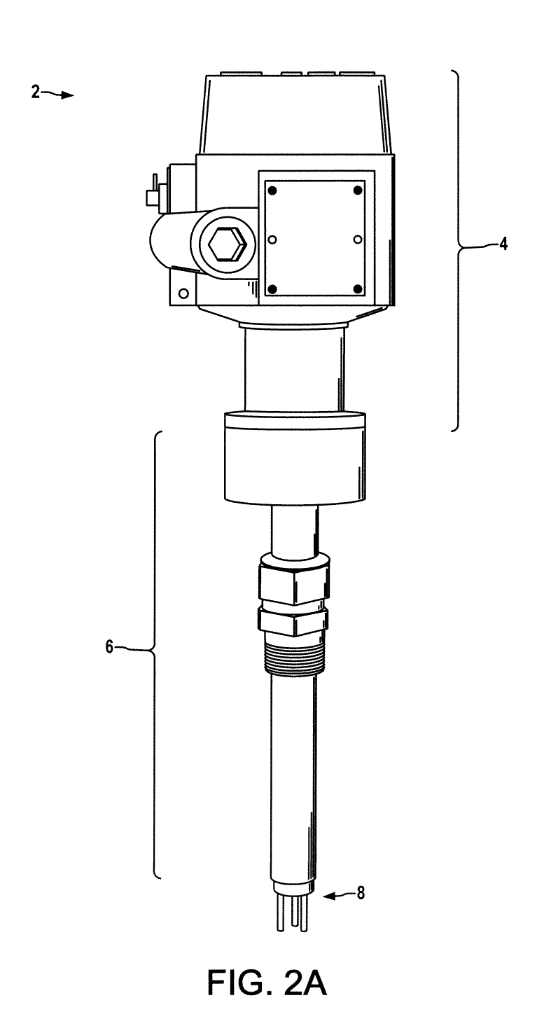

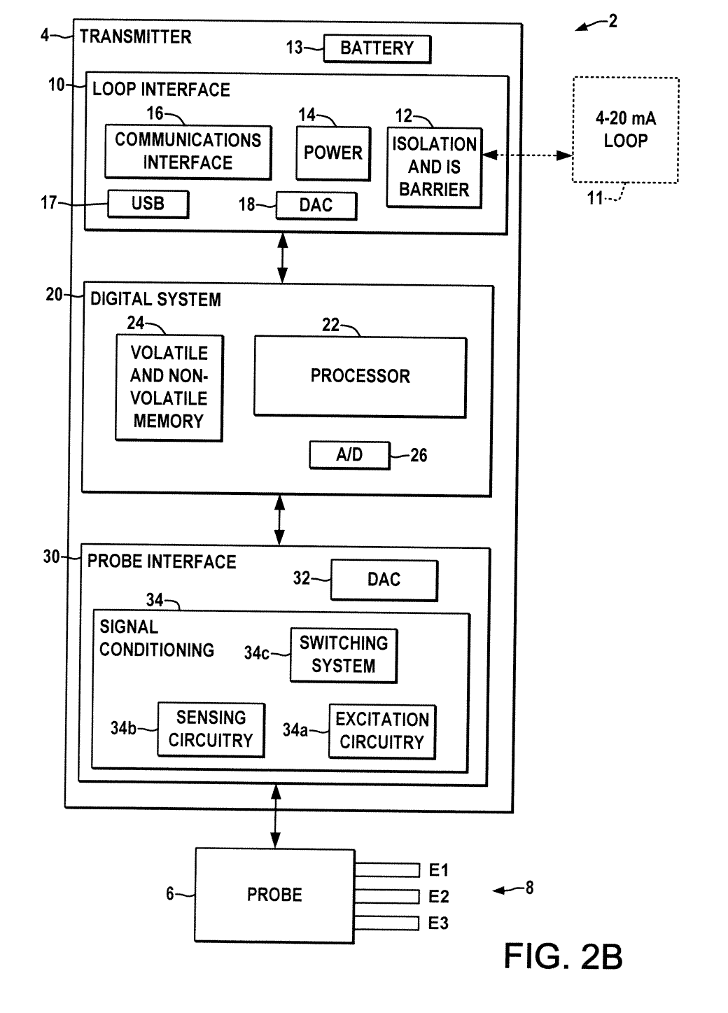

Referring initially to FIGS. 1A and 1B, an exemplary localized corrosion measurement system 2 is schematically illustrated in FIG. 1A according to one or more aspects of the present disclosure. The system 2 may be implemented as a single field device, as shown in FIGS. 2A and 2B below, or may be implemented in distributed fashion with separately housed probe interface and digital systems. As shown in FIG. 1A, the system 2 includes a probe interface system 30 with a signal conditioning circuit 34 to interface with a plurality of measurement electrodes 8 situated in the electrolyte, the signal conditioning circuit 34 with a sensing circuit 34b that senses corrosion-related voltage and/or current signals via at least one of a plurality of electrodes 8 associated with a probe 6. A digital processing system 20 is provided, in one embodiment having a processor 22 that implements a high-pass or band-pass filter 25 to remove low-frequency components from sensed corrosion-related signals obtained in digital form from the probe interface 30 via and analog-to-digital (A/D) converter 26.

In one embodiment, the system 2 is operated generally in accordance with an exemplary localized corrosion measurement or monitoring process 300 illustrated in FIG. 1B. The process 300 includes sensing an electrochemical noise (ECN) value at 302, such as current or potential between two of the electrodes 8 when no excitation is applied to the electrolyte. At 304, low frequency components of the sensed signal are removed, such as by analog or digital filtering, and a standard deviation value σ is computed at 306 based at least partially on the filtered signal values. The processing system 20 computes a standard deviation value σ which is indicative of the presence or absence of localized corrosion on the structure of interest, at least partially according to filtered corrosion-related signal samples from the A/D converter 26, and then scales the standard deviation σ at 308 to provide a localized corrosion value (LCV) 27, which can then be stored in the memory 24. In one embodiment, the filter 25, whether high-pass or band-pass, is a digital filter that removes low-frequency components of about 0.05 Hz or less from the sensed corrosion-related signals. The filtered samples in one example are provided to an n-stage digital filter implemented by the processor 22, such as a 15-stage digital filter with a high-pass cutoff frequency of about 0.04-0.06 Hz, preferably 0.05 Hz. In one embodiment, the A/D converter 26 is controlled in an ECN measurement cycle to obtain 300 samples over approximately 5 minutes at a 1 second sample period. The processor 22 performs the digital filter functions 25 and computes a standard deviation value σ by any suitable formula or algorithm, such as ((Σ(x−mean)²)/N)^{1/2} in one example, where N is the number of samples and “mean” is the mean of the samples. In an exemplary embodiment, the standard deviation σ is computed using a running moment calculation M2 (σ=the square root of M2) as detailed further below.

The processor 22 then scales the standard deviation σ at 308 to provide the localized corrosion value 27 in a range of 0 to 1. In one embodiment, the standard deviation value σ is scaled by the input measurement range of the sensing circuitry 34b and the A/D converter 26. For example, the deviation σ can be scaled to the current noise measurement range using empirical measurements of no localized corrosion and high localized corrosion to establish two bounds of the input measurement range in A/D count values corresponding to measured ECN currents. The standard deviation σ is then scaled by this measurement range in one embodiment to derive the localized corrosion value 27 at 308 which has a value between 0 and 1 inclusive, with any computed scaled values exceeding 1 being set to equal 1 to account for other high-localized corrosion environments beyond that used to establish the scaling range. In possible embodiments, the scaling range is given by the dynamic range of the circuitry and may be verified by experimental tests to be optimal.

Referring also to FIGS. 1C-1E, the inventors have appreciated that filtering the electrochemical (potential or current) noise signal using a high-pass or band-pass digital filter advantageously facilitates improved measurement of localized corrosion using the higher frequency components which are substantially free of general corrosion effects. In this regard, the inventors have recognized that while localized corrosion noise has a wide frequency spectrum, believed to include low frequency components, the general corrosion component of the noise signal does not have frequency components in the range of 0.05 Hz and above, and that using a high or band-pass filter 25 advantageously separates the general corrosion process signal from the localized corrosion process signal of interest. The standard deviation σ of the filter output provides a measure of the amplitude of the higher frequency noise, and accordingly is directly related to the amount of localized corrosion activity. Scaling this value to a scale of 0 to 1 provides a simple and easily understood measure of localized corrosion attack. FIG. 1C shows a graph 350 illustrating a sensed ECN voltage value 352 over time (in mV before application of a 625 mV center offset) in a situation with little or no localized corrosion and no low frequency noise for a titanium electrode in drinking water. The graph 360 in FIG. 1D shows a sensed ECN value curve 362 over time in a different situation for carbon steel in 3% NaCl with little or no localized corrosion where a significant amount of low frequency noise is present, but relatively little high frequency noise is observed. The electrode in this case is undergoing general uniform corrosion attack with a significant variation in the signal level, but the fluctuations are relatively slow. In this situation, basing the localized corrosion computation on a standard deviation of the unfiltered signal in the curve 362 would lead to a misleadingly high localized corrosion value, since there is little, if any, localized corrosion occurring. FIG. 1E provides a graph 370 showing a sensed ECN value curve 372 for aluminium in acidified 3% NaCl solution. The electrode is in this case undergoing localized pitting corrosion and both low and high frequency components of the noise signal are present.

The exemplary system 2 employs a high or band-pass filter 25 to separate the high frequency ECN fluctuations (which are indicative of localized corrosion attack) from the slower variations (which do not) and computes the standard deviation σ of the filtered signal in generating the localised corrosion index or value 27. The standard deviation value σ is then used to calculate the localized corrosion index parameter 27, in one embodiment, by scaling the deviation σ by the input signal range to provide the index value 27 as a unitless value ranging from 0 to 1. The inventors have appreciated that computing the standard deviation σ using the filtered signal values facilitates differentiation between the cases shown in FIGS. 1D and 1E with respect to localized corrosion by virtue of the initial removal of the low frequency components, thus yielding different localized corrosion values 27 for those two cases. All previous approaches and localized corrosion index calculation algorithms, not employing the filter 25, might incorrectly yield similar localized corrosion index values for the cases of FIGS. 1D and 1E, such as those techniques that computed the standard deviation of the raw (unfiltered) sensed signals and scaled the deviation by the RMS of the signal.

In the illustrated system 2, the ECN signal (e.g., either sensed potential or current) is detected and amplified by the sensing circuitry 34b, and the resulting analog signal is digitized using the analog-to-digital converter 26 of the processing system 20.

The digital samples are processed using the digital high-pass or band-pass filter 25 and the standard deviation σ of the filter output over a period of time is computed by the processor 22. In one embodiment, a high-pass digital filter 25 is employed, such as a 15 stage finite impulse response (FIR) filter with a cut-off frequency of 0.05 Hz, using the following exemplary filter coefficients for a sample rate of one sample per second:

a[0]=−0.046956,

a[1]=−0.0284518,

a[2]=−0.04213,

a[3]=−0.056783,

a[4]=−0.0707939,

a[5]=−0.0824234,

a[6]=−0.09012,

a[7]=0.8353165,

a[8]=−0.09012,

a[9]=−0.0824234,

a[10]=−0.0707939,

a[11]=−0.056783,

a[12]=−0.04213,

a[13]=−0.0284518, and

a[14]=−0.046956.

Other suitable high-pass or band-pass filters may be used, of any digital length, or even filters of analog design. In certain embodiments, moreover, the system is operable in a series of device cycles to take a given number of ECN samples for use in computing a current localized corrosion value 27 that is stored for later user retrieval, for example, 315 sensed ECN potential or current samples taken at one second intervals for a period of about 5 minutes, with the first 15 samples being discarded and the remaining 300 samples being used in the standard deviation calculation. As the low frequency electrochemical noise components are filtered out and discarded, there is no practical advantage in sampling the noise signal for more than about ten times the filter cut-off frequency period. The ECN measurement can therefore be carried out in a considerably shorter time period than would be necessary were the filter not used.

In some implementations, the standard deviation σ may be computed in real time using a ‘running mean’ algorithm implemented in the processor 22 to thereby mitigate the amount of intermediate data storage in the system 2.

In order to provide the end user with an easily understood localized corrosion index parameter it is advantageous to scale the calculated standard deviation to a range from zero (no localized corrosion) to one (severe localized corrosion). A number of scaling factors and relationships may be used, depending on the sensitivity of the electronic circuitry used and the surface area of the probe electrodes.

For example, in one current noise measurement implementation where the measurement range extends from a lower limit of 3×10⁻⁹ A/cm² to 3×10⁻⁶ A/cm², the localized corrosion index value 27 may be computed as:

$$Localised Corrosion Index = \frac{{log}_{10} ( standard deviation )}{3} - \frac{{log}_{10} ( 3 \times {10}^{- 9} )}{3} ,$$

where the second term is a constant determined by the sensitivity of the circuitry and the surface area of the probe electrodes 8, and this second term can be tailored for a given system.

Referring also to FIGS. 2A and 2B, one embodiment of the system is shown in the form of a field corrosion measurement device 2 in FIG. 2A that may be loop powered via a 4-20 mA loop, or may be battery powered. The system 2 includes a transmitter head 4 that houses processor-based electronic circuitry as described below, as well as a probe 6 and a set of three electrodes 8 which are preferably made of a material matching that of a metal structure into which the device 2 is installed for corrosion monitoring/measurement, where the electrodes 8 are immersed or embedded in the solution or other electrolytic solid, gas, or liquid stored or transported in the installed structure, such as a pipeline, storage tank, or other structure of interest. In a typical installation, the probe 6 is mounted to a structure of interest with the electrodes extending into the interior of a pipe or fluid chamber so as to be exposed to a corrosion process therein. The transmitter housing 4 and the probe 6 are constructed of environmentally protective materials to allow use of the device 2 in field applications such as for online corrosion monitoring to generate process variables for corrosion rate, localized corrosion index (degree of corrosion localization), and/or electrolyte resistance (conductance) or stand-alone installations as a battery powered electronic coupon where localized and other corrosion data can be uploaded by a user via a communications, device, USB memory stick, micro SD card or other suitable means. The exemplary system 2, moreover, can perform a number of different corrosion related measurements, including measuring linear polarization resistance (LPR), solution resistance (or conductance) RS, in addition to the above described electrochemical noise (ECN) measurements, for example, using the other measurement techniques described in U.S. Pat. Nos. 7,282,928; 7,265,559; 7,239,156; and 7,245,132, incorporated herein by reference.

FIG. 2B further illustrates exemplary electronics of the transmitter 4, including a loop interface 10 with galvanic isolation and intrinsic safety (IS) barrier circuitry 12 through which one embodiment of the system 2 interfaces with a standard 4-20 mA control loop 11, and a power system 14 that provides internal device power derived from either current from the control loop 11 or alternatively from a battery 13, solar panel (not shown) or other source. The loop interface 10 further includes a communications interface 16 operatively coupled with a processor 22 of a digital system 20 and with the control loop 11 to allow the processor 22 to communicate using HART or other communications protocol(s) with an external communications device (not shown) by which a user may configure or program the device 2 and/or may retrieve stored computed corrosion related values from the device 20. The exemplary loop interface 10, moreover, includes a dedicated digital-to-analog converter (DAC) 10 for controlling the current in the loop 11 so as to allow the processor 22 to control current in the loop to indicate a measured/computed process variable (e.g., loop current level between 4 and 20 mA corresponding to corrosion rate, localized corrosion index, conductance, etc.) and also provides for FSK or other type modulation of the loop current to perform digital communications via the loop 11 or other wired or wireless communications means according to a suitable protocol such as HART, etc.

In other embodiments, the system 2 is a field device designed for strictly battery power with no connection to a 4-20 mA loop, with the power system 14 providing power conditioning and isolation for powering the digital system 20 and probe interface circuitry 30 using current from the battery 13. The system 2, moreover, includes a USB port 17 with associated driver circuitry allowing a user to install a USB memory stick or other USB device to which the system 2 downloads saved corrosion measurement data (such as localized corrosion values 27). This allows the system 2 to operate in a low-power mode, with the device 2 having a real-time clock for programmable operation in measurement mode according to a programmable schedule in which the system 2 performs one or more corrosion measurements (e.g., including ECN localized corrosion measurements), such as once per hour, several times per day, etc. The user can then visit the device 2 and connect a communication device or insert a USB memory stick to obtain the stored measurement data that has been collected by the system 2. In other embodiments, the unit 2 may include a micro SD card interface for data uploading.

The digital system 20 comprises a processing system 22, which can be any form of processing circuitry such as a microprocessor, microcontroller, digital signal processor (DSP), programmable logic, etc., by which the various functionality described herein can be accomplished. The digital system 20 includes one or more forms of memory 24, in particular, non-volatile memory such as flash, FRAM, etc., and may include an analog-to-digital converter (A/D) 26, wherein the A/D 26 and or the memory 24 may be separate components or circuits, or may be integrated in the processor 22.

The exemplary probe interface system 30 includes signal conditioning circuitry 34 to interface with a plurality of measurement electrodes 8 situated in the electrolyte to be measured, as well as a DAC 32 for generating excitation signals to be applied by the signal conditioning circuitry 34 to at least one of the electrodes 8 for certain measurement types. Excitation circuitry 34a provides excitation signals according to the output of the DAC 32 to the electrolyte via a first electrode E1 (auxiliary electrode), and circuitry 34b senses one or more corrosion-related electrical signals, such as voltages, currents, etc., via one or both of the other electrodes E2 and/or E3, wherein the second electrode E2 is referred to herein as a reference electrode used for sensing voltage signals in the electrolyte, and the remaining electrode E3 is referred to as a work or working electrode. A switching system 34c with a plurality of analog switching components allows processor controlled reconfiguration of the various components of the excitation circuitry 34a and the sensing circuitry 34b and the electrodes 8 in a plurality of different configurations.

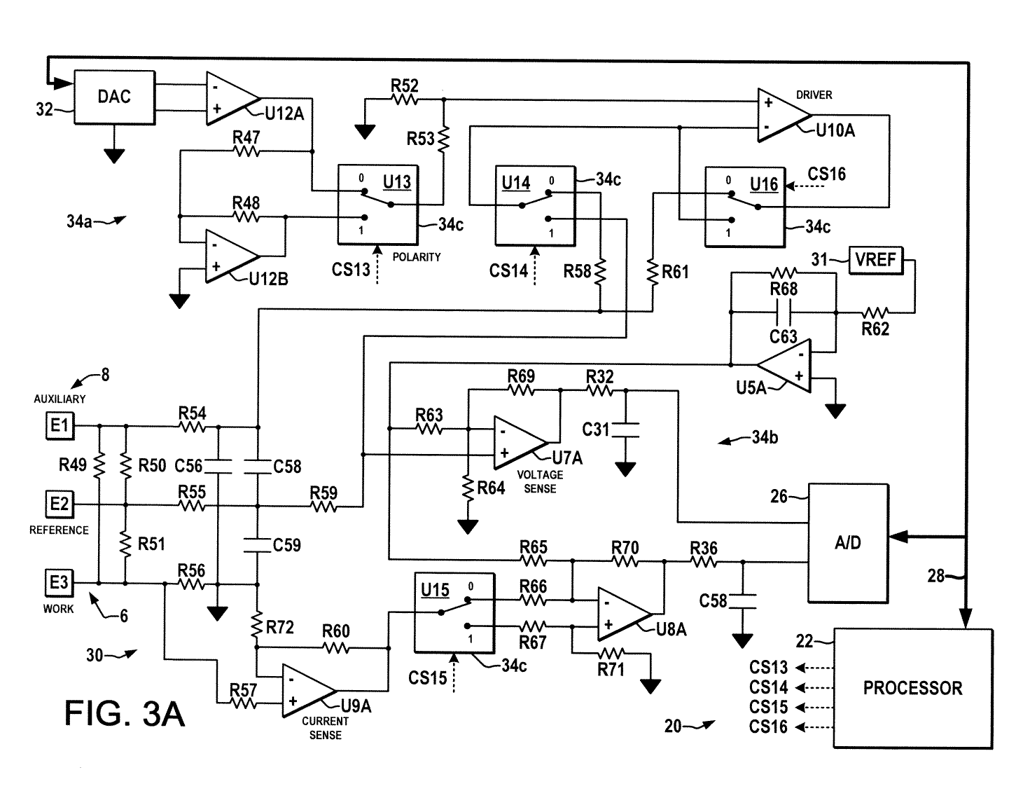

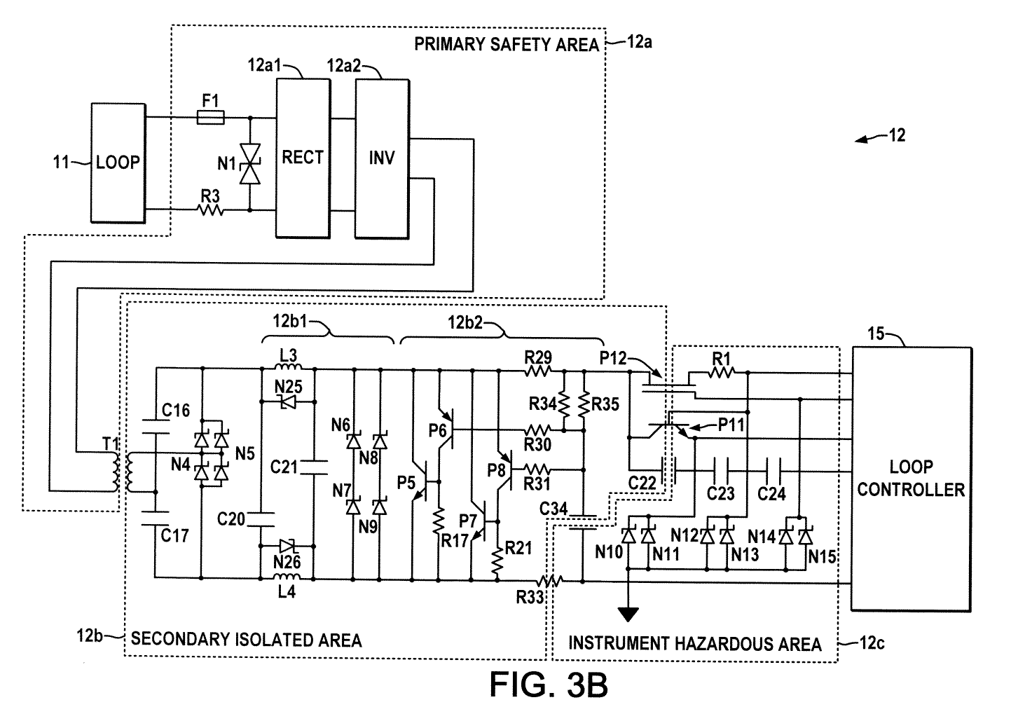

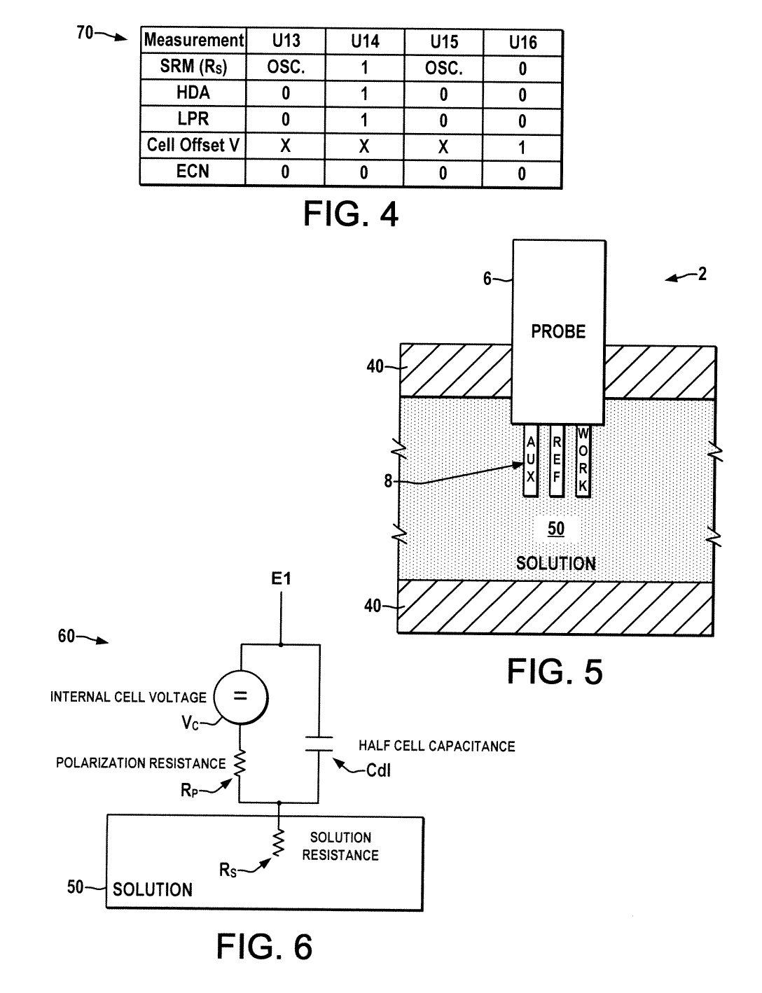

FIGS. 3A, 3B, and 4 illustrate further details of the probe interface system 30 and the digital system 20, including the excitation circuitry 34a, sensing circuitry 34b, and the switching system comprised of four analog switching devices 34c labeled U13-U16 in FIG. 3A. Each of the analog switches U13-U16 has two switching states, indicated in the figure as a “0” state and a “1” state, wherein the processing system 22 provides corresponding switching control signals CS13-CS16 to control the state of each switch 34c. The analog switches U13-U16, moreover, can have a third operational state controlled by a chip select input (not shown) in which the switch terminal is disconnected from either of the pole terminals. The switches U13-U16 are thus coupled for processor controlled interconnection of the components of the excitation and sensing circuits 34a and 34b to reconfigure the corrosion measurement device 2 in a number of different corrosion measurement arrangements, wherein FIG. 4 shows a table 70 illustrating the switch settings or states for SRM, HDA, LPR, Cell Offset Voltage, and ECN measurement operation of the device 2. The exemplary device 2 may be programmed by a user to operate in any single one of the measurement modes in FIG. 4 or may perform measurements in any combination of two or more of the listed measurement types in each of a series of device cycles, whereby the system 2 is easily configured to accommodate any corrosion measurement or monitoring application.

The processor 22 controls the excitation DAC 32 during each measurement period to provide suitable excitation to the cell via the excitation circuitry 34a, the first (auxiliary) electrode E1, and the switching system 34c, and also operates the measurement A/D 26 to obtain corresponding measurements of cell voltages and/or currents via the sensing circuitry 34b, the switches 34c, and the reference and working electrodes E2 and E3, respectively. The electrode couplings are made through the probe 6 with resistors R49-R51 and filter network R54-R56, C56, C57, and C58 forming the connection to the excitation and sensing circuitry 34a and 34b. In the scenarios described below, the device 2 performs a series of measurements in each device cycle through controlled switching of the devices U13-U16. In the illustrated device 2, moreover, certain of the selectable measurement types (e.g., SRM, HDA, and LPR) involve application of excitation signals, while others (e.g., ECN) do not, wherein general corrosion is computed using HDA or LPR measurement types, electrolyte resistance or conductance is measured using SRM techniques, and ECN measurements are used in computing localized corrosion index values. Excitation signals (if any) are applied to the auxiliary electrode E1 as voltage signals provided by the DAC 32 in either a first polarity using a first amplifier (e.g., opamp) U12A directly through the “0” state path of the switch U13 or in an opposite second polarity via an inverter configured amplifier U12B through the “1” state of the switch U13 with a driver amplifier U10A providing a corresponding output voltage to the auxiliary electrode E1 through the “0” state path of the switch U16 and a resistor R61. In these configurations, moreover, the electrodes are in the feedback loop of the driver amplifier U10A of the excitation circuitry 34a, whereby current flowing between the auxiliary and working electrodes E1 and E3 will cause the potential between the reference electrode E2 and the working electrode E3 to be the same as the applied excitation signal voltage. In certain operational configurations, moreover, no excitation is applied, wherein the switching system electrically isolates the auxiliary electrode E1 from the excitation circuitry 34a while the processing system 22 samples voltage signal sensed across E2 and E3 by the sensing circuitry 34b.

The return current resulting from any applied excitation voltage signals flows through the working electrode E3 in the exemplary three electrode potentiostatic measurement configuration, wherein the sensing circuitry 34b senses such currents via a current sense amplifier U9A forming a current to voltage converter with a current sensing resistor R56 to generate an output based on the voltage across R56 via resistors R57, R60, and R72. This current to voltage converter of the sensing circuitry 34b is used for sensing current in HDA and ECN measurements, and is also used in combination with a synchronous rectifier in measuring the polarization resistance LPR.

The current to voltage converter amplifier U9A provides an output to either an inverting input or a non-inverting input of amplifier U8A for the “0” and “1” states of the switch U15, respectively, where the output of U8A provides one of two inputs to the A/D converter 26 for current sensing. The current sense polarity switch U15 may thus be operated as a rectifier for certain measurement types to achieve toggled switching via the control signal CS15 from the processor 22. In this regard, when the excitation polarity switch U13 and the current sense polarity switch U15 are operated synchronously (by controlled switching of control signals CS13 and CS15 by the processor 22), these analog switching components constitute a synchronous rectifier used in certain embodiments for measuring the electrolyte (solution) resistance R_{S} (SRM mode). The current sensing components, moreover, are employed without toggling of the polarity switch U15 for measurement of sensed currents from the working electrode E3 in performing HDA, LPR, and ECN measurements in the corrosion measurement device 2. The sensing circuitry 34b further provides voltage sensing capability with an amplifier U7A driving the second analog input of the A/D 26 for sensing the voltage at the reference electrode E2 through a high impedance path R59, which is compared with a reference voltage VREF 31 using amplifier U5A.

The A/D 26 can thus obtain and convert analog voltage and current values under control of the processor 22 and then provides digital values for these measurements to the processor 22. The A/D converter 26, moreover, can be any suitable conversion device, such as a delta-sigma modulator based converter in one embodiment, and is preferably operated at a relatively slow conversion rate. For example, the A/D 26 in the illustrated embodiments is operated to obtain measurement samples of the various corrosion related sensed signals at a sample rate significantly lower than the excitation signal frequency, such as less than about 10 samples per second, for example, sampling once every 0.3 second in one embodiment, in order to remain within the power budget of the power system 14 for loop or battery powered implementations. The processing system 22 is thus operatively coupled with the probe interface system 30 to control the excitation signals provided to the electrolyte by the excitation circuitry 34a and to provide control signals CS13-CS16 to the switching system 34c to selectively reconfigure the switching components U13-U16 to perform a plurality of different corrosion measurement types and to compute at least one corrosion related value based on received measured values from the sensing circuitry 34b.

As shown in FIGS. 2A-3B, the exemplary system 2 includes isolation and intrinsic safety (IS) barriers 12 providing galvanic isolation of the electrodes E1-E3 and the circuitry of the device 2 from a 4-20 mA loop 11. In this embodiment, loop current passes through an input stage of a primary safety area 12a with a fuse F1, a surge protector N1 and resistor R3 and a rectifier 12a1, followed by an inverter 12a2, which provides an input to an isolation transformer T1. The isolated output of the transformer T1 provides an input to a secondary isolated area 12b, including a voltage protection circuit 12b1 comprising voltage limiting zeners N6-N9 and current limiting circuits formed of transistors P5-P8 and resistors R17, R21, R29-30, R34, R35, and capacitor C34. The output of this first intrinsic safety barrier stage 12b provides an input to a second IS barrier stage 12c including further voltage limiting zeners N10-N15 thereby further limiting the possible voltage seen by a loop controller circuit 15. The IS protection of the device 2 also provides 1 KOHM protection resistors R57-R61 to protect the electrodes E1-E3. In operation, the measured electrolyte and the electrodes E1-E3 are typically connected to an earth ground, whereby the front end of the probe interface circuitry 30 is also grounded through a low impedance path.

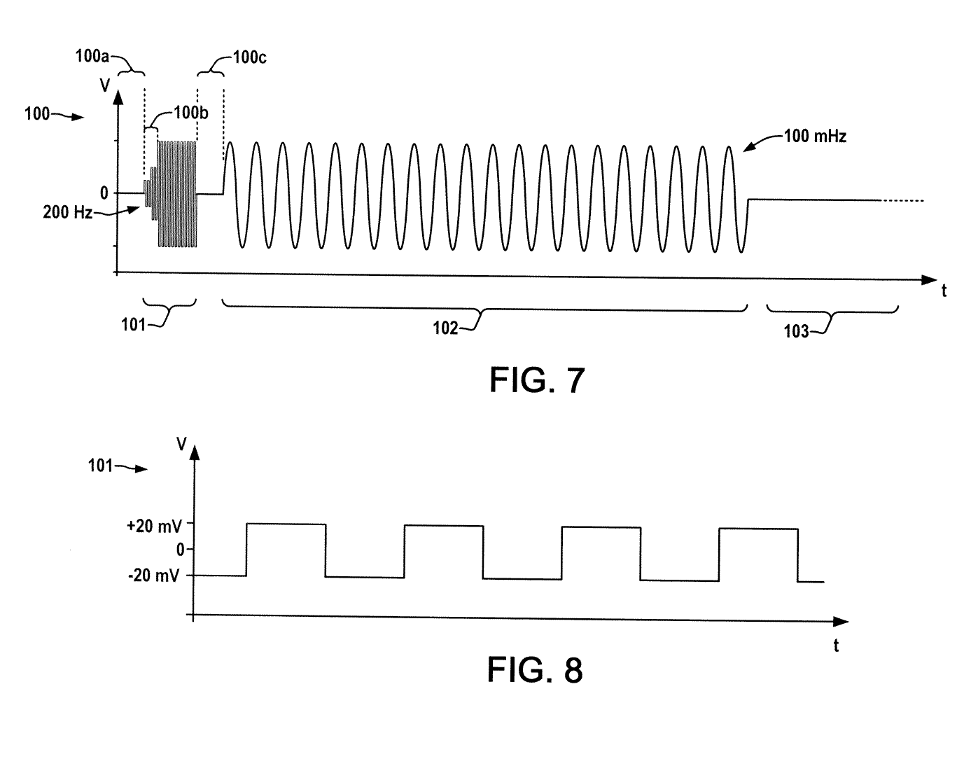

Referring also to FIGS. 5-7, in operation, the probe 6 is installed with the electrodes 8 being immersed in a electrolyte 50 being transported in a pipe or other metal structure 40, as illustrated in FIG. 5. FIG. 6 shows an equivalent electrical circuit 60 for one of the electrodes E1 and the measured electrolyte 50 in the installation of FIG. 5, wherein the electrical circuits of the other electrodes E2 and E3 are equivalent to the circuit represented in FIG. 6. The electrode/electrolyte circuit 60 in FIG. 6 includes the series combination of an internal cell voltage V_{C} and a polarization resistance R_{P} which are in parallel with electrochemical double layer capacitance Cdl between the electrode E1 and the electrolyte 50, where the electrolyte 50 has a resistance R_{S} which is the subject of SRM measurements. As shown in an excitation signal graph 100 of FIG. 7, the signal measurements in one possible configuration of the transmitter device 2 are performed in three measurement periods 101, 102, and 103 that may alternatively be in any order in each of a series of device cycles, or the device 2 may be programmed to perform only one measurement per device cycle, or any combination of two or more measurement types in a given device cycle. In this configuration, the SRM measurement proceeds initially to provide the solution resistance value R_{S}, which is then used in the LPR or HDA measurements in determining the corrosion rate to correct for any errors in the computation of the polarization resistance R_{P}, as these resistances R_{S} and R_{P} are essentially in series as shown in FIG. 6.

In the first measurement phase 101 of the exemplary configuration shown in FIG. 7, a synchronous rectifier is operated initially in period 100a for offset measurement as described further below, after which the amplitude of the AC excitation signal is dynamically adjusted in period 100b. A relatively high frequency ac excitation signal is applied thereafter in portion 101 for solution resistance/conductance measurement, followed by a gap 100c in which offsets are measured due to imbalances caused by non-identical electrodes 8. In the first phase 101, moreover, the device 2 advantageously applies an AC waveform with a mean of zero (substantially free of DC offset) to avoid polarizing the working electrode interface. Moreover, in the exemplary device 2, the DAC 32 and processor 22 are operated at low speeds (for power conservation), wherein the DAC output during SRM is set to a given dc level and the output polarity is switched using the switching system 34c to generate a bipolar square wave excitation signal for SRM measurements. In order to minimize the effects of possible small DC cell currents created by the SRM measurements in phase 101, the duration of the phase 101 is set to be as short as possible and the gap period 100c is provided with no polarization following the SRM measurements and before the LPR measurement in phase 102, thereby allowing the working electrode interface to depolarize.

In the first phase 101, the electrolyte (solution) resistance R_{S} (and hence the electrolyte conductance 1/R_{S}) is measured using high frequency square wave excitation. In the second portion 102, the device 2 applies a lower frequency sine wave excitation voltage and measures current and the associated harmonics for determining the corrosion rate using LPR and/or HDA techniques. In the third portion 103, no excitation is applied, and the device measures electrochemical noise using ECN measurements for determining the localized corrosion index value 27.

During the first portion 101 of the device cycle, the processor 22 causes the switching system 34c to configure the switches U13-U16 as shown in the SRM row of table 70 in FIG. 4, with U14 and U16 in the “1” switch states and with the synchronous rectifier operating with the switches U13 and U15 being toggled synchronously under control of the processing system 22 to provide a square wave excitation current sense rectifier frequency of less than about 500 Hz, preferably about 100-200 Hz, wherein the graph 100 in FIG. 7 shows operation at a frequency of about 200 Hz in the first measurement period 101. It is noted in the equivalent circuit of FIG. 6 that application of a relatively high frequency (e.g., above about 50 Hz for example) will effectively short the upper leg because of the capacitance Cdl, wherein the resulting AC current sensed via the working electrode E3 will be inversely proportional to the electrolyte resistance R_{S}. Other waveforms could be used for the SRM measurement, such as sine waves, square waves, etc. The illustrated SRM measurement in period 101 involves provision of the square wave excitation voltage at the auxiliary electrode E1 together with the measurement by the sensing circuit 34b and the A/D 26 of the cell current sensed at the working electrode E3, wherein the DAC 32 (FIG. 3A) provides a DC output signal at a level controlled by the processor 22 with the switching of U13 alternating the polarity of the applied excitation voltage at the excitation frequency controlled by the processor 22 via control signal CS13. The resulting sensed cell current at the working electrode E3 will also be a square wave at the excitation frequency. The processor 22 also operates the current sense polarity switch U15 via signal CS15 to toggle at the same frequency, whereby the sensed AC current signal will be rectified to present a rectified input signal to the A/D converter 26. In order to conserve power, the processor 22 controls the sampling of the A/D converter 26 at a much lower frequency, such as about 3.3 Hz in one embodiment. The processor 222 thus obtains many readings of the sensed current and averages these readings to compute the average sensed current, which is then used to compute the electrolyte resistance R_{S}.

Referring also to FIG. 8, operation of the synchronous rectifier allows the provision of a substantially dc-free excitation signal to the auxiliary electrode E1 so as not to exacerbate corrosion in the cell, while the rectification of the sensed current signal via U15 allows the A/D converter 26 to be operated at a low sample rate and hence to conserve power, while taking enough samples to allow the processing system 22 to obtain an accurate average current value, wherein absent such rectification, the average current value would be zero or near zero. In this regard, it is noted that application of de voltages to the auxiliary electrode alters the electrochemistry of the corrosion process being measured and may therefore interfere with any subsequent corrosion rate measurements. In addition, the rectification in the current sense circuitry will effectively eliminate any dc in the sensed current attributable to non-identical electrodes 8 by essentially chopping such dc component into an ac component with a mean value of zero. Moreover, the synchronous rectification also operates to reject interference at frequencies other than the switching frequency. FIG. 8 illustrates one possible substantially dc-free square wave excitation signal waveform applied during the first measurement period 101 by operation of the DAC 32 and the synchronous rectifier, having an amplitude of approximately +/−20 mV, wherein the DAC 32 of FIG. 3A provides a substantially constant dc value which is then polarity switched by toggling of the switch U13 to create the excitation waveform at the auxiliary electrode E1. The device 2 thus advantageously provides a non-intrusive dc-free square wave excitation signal in the first measurement period 101, while providing for synchronous rectification allowing slow sampling of the sensed current in performing SRM measurements within the limited power budget of loop or battery power along with rejection of dc and noise.

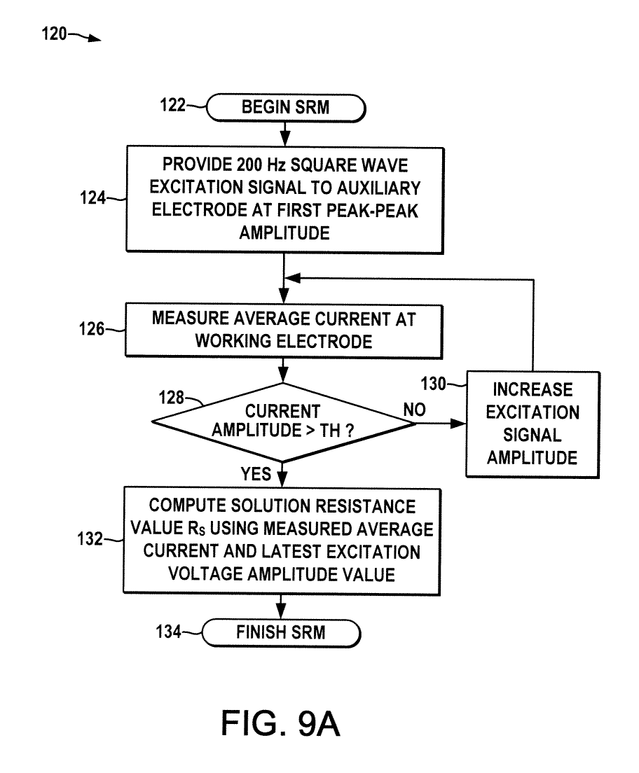

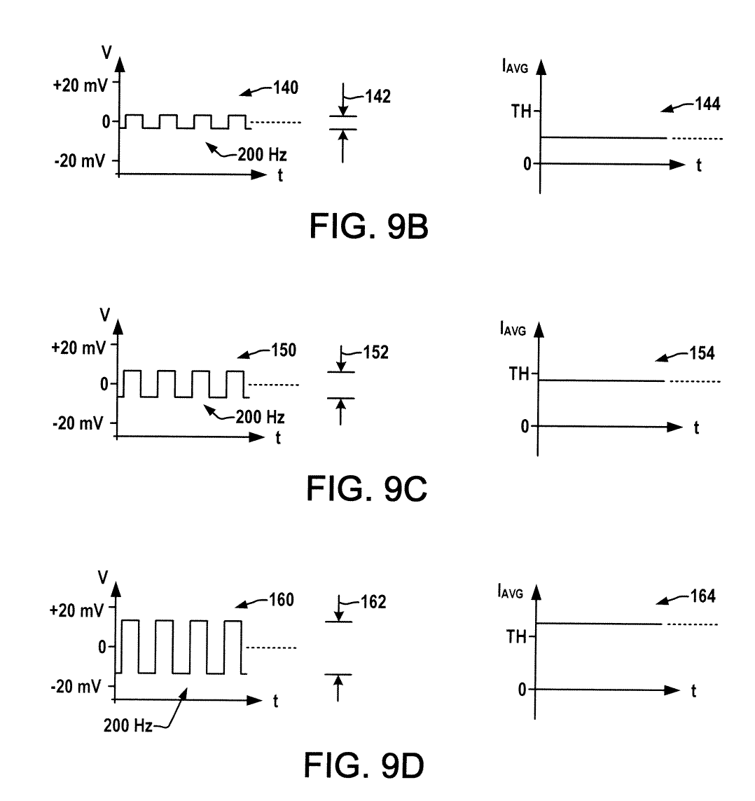

Referring also to FIGS. 9A-9D, certain embodiments of the system 2 are operable to adjust the magnitude or amplitude of the square wave excitation signal in SRM measurements either at predefined time periods, or at the beginning of each SRM measurement period 101. This facilitates improved usage of the input range of the A/D converter 22, thereby facilitating improved accuracy in the measured current samples, and in the computed average current value and hence improved electrolyte resistance (or conductance) measurements. A process 120 in FIG. 9A illustrates this exemplary operation, wherein the SRM cycle 101 begins at 122 and a relatively high frequency square wave excitation signal is provided at 124 to the auxiliary electrode E1 at a first (e.g., low) peak-to-peak amplitude. In one example, the square wave frequency is about 200 Hz, although other values may be used, preferably about 500 Hz or less. FIGS. 9B-9D illustrate graphs 140, 144, 150, 154, 160, and 164 showing voltage and current plots of square wave excitation voltages and corresponding measured average currents for different excitation waveform amplitudes according to the process 120 in FIG. 9A. In the first plot 140 of FIG. 9B, a square wave of about 200 Hz is applied at a relatively low first amplitude 142. The average current is measured at 126 in the process 120, for instance, by taking a plurality of measurements with the A/D 26 using the synchronous rectifier operation as described above or using other suitable techniques for measuring an average current value. A determination is made at 128 as to whether the average current value thus obtained exceeds a predetermined threshold TH, where any suitable threshold may be used by which a decision can be made regarding optimal usage of the A/D input range. In one example, the threshold is related to about half of the A/D input range although other values can be used.

If the measured current does not exceed the threshold TH (NO at 128), as shown in the current plot 144 of FIG. 9B, the excitation signal amplitude is increased at 130 (e.g., by increasing the output of the DAC 32 under control of the processing system 22), and the process 120 of FIG. 9A returns to again measure the average current at 126. This situation is shown in plots 150 and 154 of FIG. 9C, wherein the new excitation signal amplitude 152 is greater than the initial amplitude 142 of FIG. 9B. The new average current is compared with the threshold TH at 128, and as seen in the plot 154 of FIG. 9C, this current is still below the threshold TH. Accordingly, the process 120 of FIG. 9A again increases the excitation amplitude at 130 to a level 162 shown in the excitation voltage plot 160 of FIG. 9D. At this point, as shown in plot 164 of FIG. 9D, the latest excitation amplitude 162 provides for a resulting sensed average current that is greater than the threshold TH (YES at 128 in FIG. 9A), and the process 120 of FIG. 9A continues to 132 whereat the electrolyte resistance R_{S} is computed using the latest excitation voltage amplitude value, and the SRM process in period 101 is finished at 134. In this manner, the corrosion measurement device 2 is adapted to utilize the full extent of the A/D conversion range, wherein the processing system 22 correlates the known latest excitation voltage amplitude with the latest measured and computed average current value at 132 to compute the electrolyte resistance R_{S} and/or electrolyte conductance. This adaptive adjustment of the excitation amplitude facilitates the optimal usage of the available A/D resolution, and provides for adaptation of the device 2 for applications having very low or very high electrolyte conductivities without sacrificing accuracy.

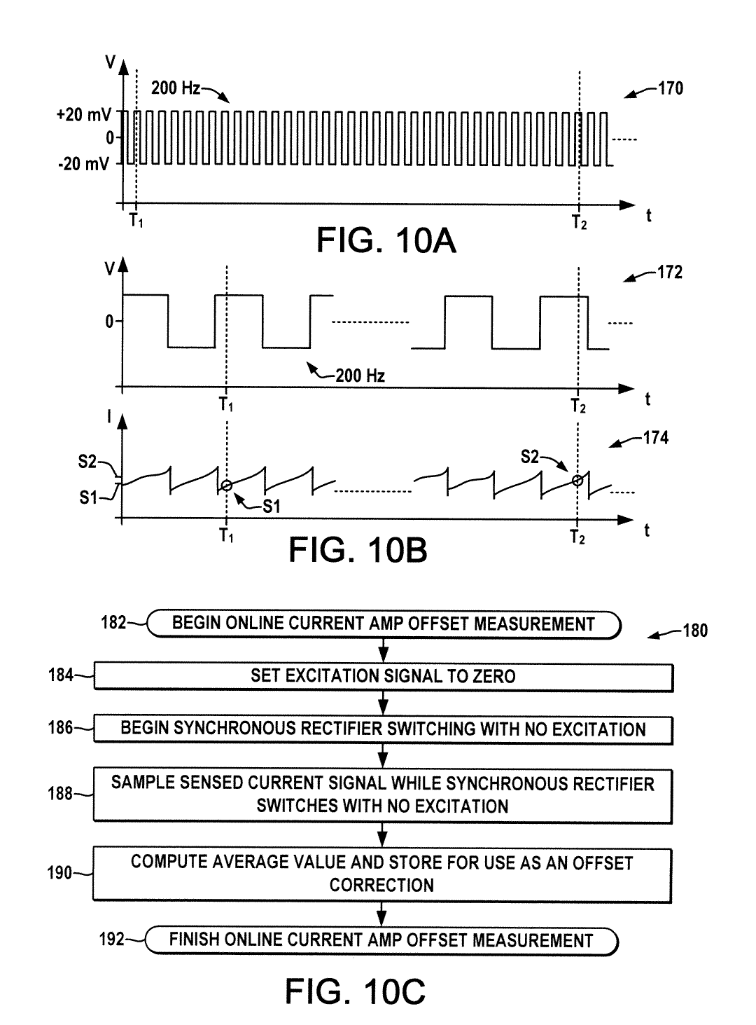

Referring also to FIGS. 10A-10C, the device 2 also provides for calibration for current amplifier offset to further refine the accuracy of the computed corrosion related values. In this regard, the usage of the synchronous rectifier described above in conjunction with asynchronous A/D sampling may lead to situations in which the measured current and the input to the A/D converter 26 increase slightly during each cycle of the square wave as shown in FIGS. 10A and 10B. The plot 170 of FIG. 10A illustrates the 200 Hz square wave voltage excitation signal employed in SRM measurements along with two exemplary asynchronous A/D converter samples S1 and S2 at times T₁ and T₂, respectively, obtained using a long A/D sample period of about 0.3 second. The graphs 172 and 174 in FIG. 10B show further details of the exemplary portions of the excitation voltage and sensed current plots, respectively, at the two exemplary sample times T₁ and T₂ in FIG. 10A, wherein it is seen that the first current sample S1 is somewhat lower than the second sample S2 simply because these were sampled at different points within the excitation cycle. In addition to these inaccuracies, offsets in the opamps U8A and U9A used to sense the current signals may contribute to reduced accuracy in computation of R_{S}, corrosion rate, and/or localized corrosion. Further inaccuracies may result from a dc offset difference between the inverting and non-inverting paths of the rectifier, the finite speed of the cell driver amplifier U10A, resistors and capacitors on the probe inputs.

In order to mitigate these inaccuracies, the device 2 provides for online current amplifier offset measurement, with an exemplary process 180 being illustrated in FIG. 10C beginning at 182 by which the device 2 automatically determines an online offset value based on a measured current amplifier offset while the synchronous rectifier components U13 and U15 are toggled by the processor 22. At 184, the processor 22 causes the DAC 32 to set the excitation signal to zero, and begins toggling the synchronous rectifier components U13 and U15 via signals CS13 and CS15, respectively, at 184 with no applied excitation voltage, wherein the rectifier components are switched via signals CS13 and CS15 at the same rate as normally used for SRM measurements as described above (e.g., at about 200 Hz in on implementations. The processor 22 obtains a number of samples of the sensed current signal at 188 using the A/D 26 and computes an average current value at 190, which is then stored for subsequent use as an offset in the above described SRM measurements, and the online current amplifier offset measurement is finished at 192. Thereafter during the SRM measurements in period 101, the processor 22 uses the stored offset to correct the current readings before computing the electrolyte resistance value R_{S}, so as to counteract the adverse effects of offsets in the current sensing circuitry including amplifiers U9A and U8A and to compensate for sampling inaccuracies associated with the synchronous rectifier operation and the asynchronous sampling of the A/D converter 26.

Referring now to FIGS. 3A, 3B, 4, 7, and 11, the system 2 also provides for improved HDA and/or LPR measurement types, wherein FIG. 4 shows the switching system configuration for these modes with respect to the switch states of U13-U16 in FIG. 3A. The system 2 is thus configurable to compute a general corrosion rate I_{CORR} using LPR or HDA techniques. Basic LPR measurements typically employ a default or user entered B-value, whereas the HDA approach involves calculation of a B-value and the corrosion rate at the same time according to measured current harmonics. The system 2 selectively employs one or the other of these techniques (HDA or LPR) according to the results of online plausibility tests using the measured current harmonics and electrolyte resistance.

The second exemplary measurement portion 102 in FIG. 7 illustrates the excitation applied in this portion 102, in which a low frequency sine wave excitation voltage is applied to the cell via auxiliary electrode E1 for LPR or HDA type measurements of current harmonics. In these measurement types, the sinusoidal excitation signal is preferably at an excitation frequency of about 0.05 Hz or more, such as about 0.1-0.2 Hz, wherein the example of FIG. 7 uses an excitation frequency of about 0.1 Hz. The processing system 22 in certain embodiments computes the corrosion related value(s) based on more than ten cycles, preferably about 20 cycles of the sensed sinusoidal current signal using harmonic distortion analysis or LPR in the second period 102. In the second period 102 of FIG. 7, the low frequency sinusoidal excitation causes a resulting sensed current signal having various frequency domain components, including a fundamental component at the excitation frequency and second and third harmonic components that are used for the corrosion related value computations in the processor 22. This harmonic information is obtained by sampling the sensed current signal and conversion thereof to digital data by the A/D 26, with the processing system 22 performing a discrete Fourier Transform (DFT) to generate a frequency domain spectrum for the sensed current. From the DFT frequency domain spectrum, amplitudes of the fundamental and various harmonics are obtained, and the harmonic measurement data is used in calculating the corrosion rate. The DFT may be computed in concert with the sine wave excitation voltage generation, wherein the sinusoidal excitation voltage is generated as a series of small steps by the DAC 32 (FIG. 3A) from a memory look-up table in the processing system 22 or the memory 24 (FIG. 2B), with the same look-up table being used for the DFT computations. In this regard, the exemplary table uses 96 steps per cycle to keep the size of the table small, and also to allow division by 2, 3, and 4. The output of the DAC 32 is preferably scaled using a resistive divider R52, R53 to decrease the size of the smallest single bit step, where the values of R52 and R53 may preferably be selected to cover the widest possible range of cell offset, while minimizing the single bit step size, and the processing system 22 may ensure that the cell offset and/or required perturbation amplitude do not exceed the available range. Furthermore, sequence delays maybe provided to allow for the effects of step changes in the sine output on the cell current to pass prior to cell current sensing/measurement by the A/D 26.

The exemplary processing system 22 evaluates the following equations (1)-(3) in each device cycle using the harmonic data obtained in the measurement period 102 to compute the corrosion current I_{corr}, from which the corrosion rate can be determined:

I_{corrharm}=I₁²/((48)^{1/2}*(2*I₁*I₃−I₂²)^{1/2}) (1)

B_{HARM}=(I_{corrharm}*Sine Amplitude)/I₁)−(R_{S}*I_{corrharm}) (2)

I_{corr}=((B_{HARM} OR B_{USER})*I₁)/((Sine Amplitude)−(R_{S}*I₁)), (3)

where I₁ is the fundamental component of the sensed current and I₂ and I₃ are the second and third harmonic components, respectively, Sine Amplitude is the amplitude of the sinusoidal excitation voltage signal applied in period 102, and B is the application specific corrosion process value in units of volts. Once the corrosion current I_{corr} is computed, this can be multiplied by constants relating to the specific electrode size, the faraday constant, and the atomic weight of the material, to calculate the corrosion rate in mm or mils per year.

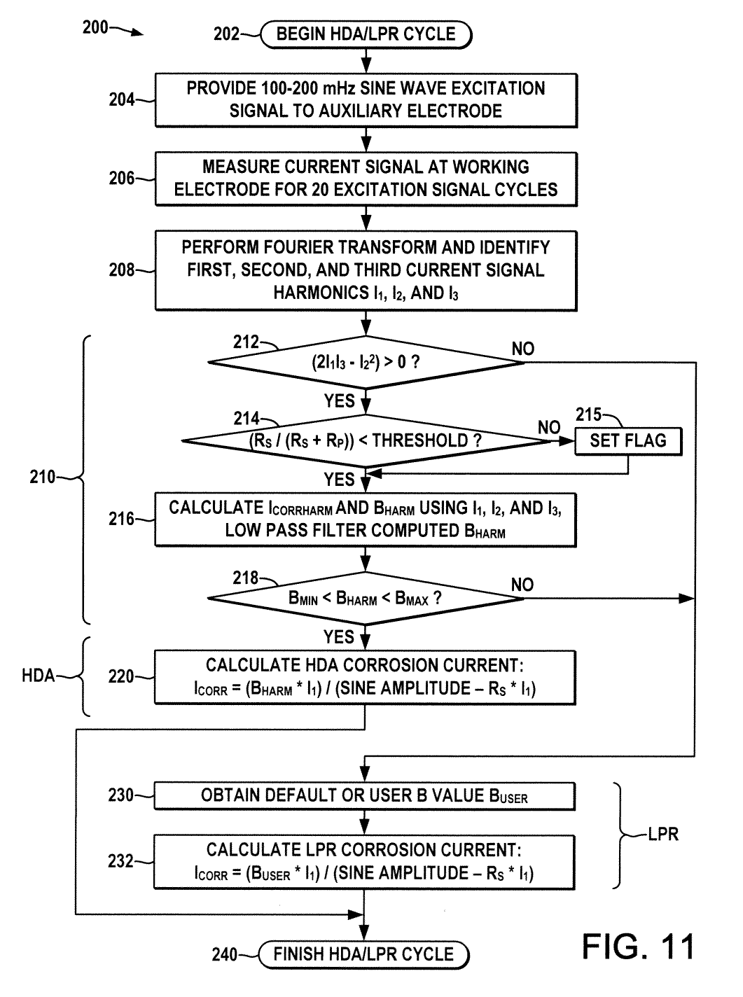

Referring also to FIG. 11, another feature of the exemplary corrosion measurement device is the computation of the B value B_{HARM} based on the measured current harmonics I₁, I₂, and I₃ and the selective use of LPR or HDA algorithms based on the calculated B_{HARM} value and the computed electrolyte resistance R_{S}. In this embodiment, HDA measurements and computations are performed if possible, and if the HDA results appear suspect based on one or more plausibility tests in a given device cycle, the processing system 22 changes to LPR type measurements. In particular, the device 2 automatically performs one or more of three types of tests to determine whether HDA computations are warranted and selectively changes the algorithm to LPR in high electrolyte resistance situations or other conditions indicating possible inaccuracy in the HDA measurements.

A dynamically changing HDA/LPR process 200 is shown in FIG. 11 beginning at 202 for the second period 102 in the exemplary device cycle of FIG. 7 above, wherein the processor 22 causes the DAC 32 and the excitation circuitry 34a to provide a sinusoidal excitation signal to the auxiliary electrode E1 at 204 and measures the current signal sensed at the working electrode E3 by the sensing circuitry 34b at 206 using the A/D converter 26. The processor 22 performs a DFT to identify the current harmonics I₁, I₂, and I₃ at 208 and then performs one or more tests at 210 to ascertain whether HDA corrosion measurements are plausible. In particular, a determination is made at 212 as to whether the quantity (2*I₁*I₃−I₂²) is positive. If not (NO at 212), the HDA type measurement is deemed to be not plausible, since the square root of the tested quantity (2*I₁*I₃−I₂²) appears in the denominator of the above equation (1). The process 200 continues to 230 in FIG. 11, whereat the processing system 22 obtains a default or user provided B value B_{USER} and employs this in the LPR corrosion current equation (3) above at 232 to compute I_{CORR} in the current period 102 whereafter the cycle ends at 240.

If, however, the first tested quantity (2*I₁*I₃−I₂²) is found to be positive (YES at 212), the process 200 proceeds to 214 where a determination is made as to the relative size of the electrolyte resistance R_{S} compared to the polarization resistance R_{P} to determine whether the harmonics are accurately measurable, wherein high R_{S} tends to linearize the cell response leading to low harmonic levels. In the illustrated embodiment, the quantity (R_{S}/(R_{S}+R_{P})) is compared at 214 against a threshold, such as about 0.1 in one example, and if less than the threshold (NO at 214), the processor 22 decides that HDA may be suspect and sets a flag at 215 before proceeding to 216. Alternatively, the process may proceed to 230 to switch to LPR operation after the flag is set at 215. If the test at 214 does not indicate high R_{S} (YES at 214), the process proceeds to a third test at 216, 218 with the processing system 22 computing I_{CORRHARM} and B_{HARM} at 216 by evaluating the above equations (1) and (2) using the measured current harmonics I₁, I₂, and I₃ and low pass filters the computed B value B_{HARM}. The computed B value B_{HARM} in the illustrated example is low pass filtered digitally (e.g., moving average or other low pass type digital filtering performed by the processor 22), to remove any short term fluctuations and invalid readings, thereby extending the device sensitivity in situations where the measured harmonics may be of very low amplitude.

A determination is then made at 218 as to whether the computed B value B_{HARM} is in a specified presumed valid range between a minimum value B_{MIN} and a maximum value B_{MAX}, such as between about 10-60 mV in one example (e.g., or other range known to be viable for aqueous electrochemistry). It is noted that the exemplary low pass filtering of the computed B value B_{HARM}, such as a moving average or other digital filter, advantageously operates to remove any short term fluctuations and occasional rogue readings, whereby the device sensitivity may be enhanced with respect to low amplitude harmonic situations by using the filtered or smoothed computed B value. In one example, the filtered value B_{HARM} is computed as (1−X)*B_{HARM(n-1)}+X*B_{HARM(n)}, where X in one implementation is about 0.05. If B_{HARM} is not in the test range (NO at 218), the HDA technique is suspect, and the process 200 proceeds to 230 and 232 as described above. Otherwise (YES at 218), the processing system 22 calculates the corrosion current at 220 using HDA techniques by evaluating the above equation (3) using the computed B value B_{HARM}.

Yet another feature of the corrosion device 2 is the ability to utilize the computed B value B_{HARM} (e.g., preferably low pass filtered) in performing LPR type measurements instead of a predefined user B value B_{USER}. In one embodiment, the processing system computes a B value based on harmonics of current signals sensed by the sensing circuitry in each device cycle according to the above equation (2) and computes the corrosion related value(s) using equation (3) based on B_{HARM}. In addition, the user may configure the device 2 for LPR measurements using a user B value B_{USER}, which may be obtained by any suitable means such as correlating weight loss data from test coupons, electrical resistance probes or wall thickness measurements, with LPR readings, wherein the computed B value B_{HARM} may be monitored by a user or DCS to which the device 2 is connected. In this regard, observed changes in the computed B value B_{HARM} may indicate changes in process electrolyte composition changes or other process events of interest from a process control/monitoring perspective.

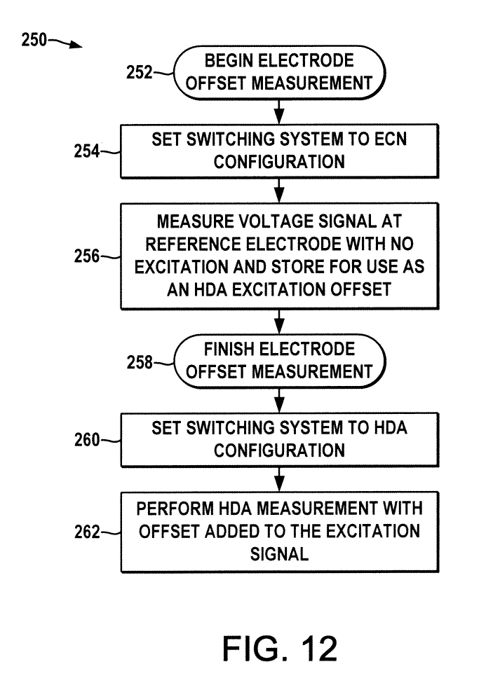

Referring also to FIG. 12, another feature of the device 2 is the adjustment of the sine wave HDA/LPR excitation signal to compensate for differences in the electrodes 8. In this regard, in the ideal cell with identical electrodes 8, no net dc current would flow between the electrodes over a whole cycle of a sine wave excitation, in which case, the electrochemistry of the working electrode E3 would not be disturbed. However, assuming non-identical electrodes 8, a goal is to ensure that when no excitation is applied by the device 2, the current through the working electrode E3 is zero. Since the electrodes 8 are in the feedback loop of the driver amplifier U10A, the current flowing from the auxiliary electrode E1 to the working electrode E3 causes the potential between the reference and working electrodes E2 and E3 to be the same as that of the applied excitation.

In the example of FIG. 12, the processing system 22 switches the analog switches at 254 to the states indicated for ECN measurement in the table 70 of FIG. 4. Thus configured, the voltage signal at the reference electrode E2 is measured at 256 with no excitation, and is stored for use as an excitation offset during the HDA measurements, whereupon the online electrode offset measurement is finished at 258. Thereafter, the switching system 34c is switched at 260 by the processor 22 to the HDA configuration shown in the table 70 of FIG. 4, and the HDA measurements are taken at 262 with the offset value added to the excitation signal by the DAC 32 under control of the processor 22. In this manner, the device 2 performs the HDA measurements during the second measurement period 102 of FIG. 7 using the offset so as to compensate for any inaccuracies otherwise attributable to differences between the electrodes 8. By measuring the cell offset before the HDA is performed and adding the measured offset to the applied sine wave, any currents that are caused by the electrode differences are effectively eliminated during HDA measurement, whereby the device compensates for physical differences between the electrodes E1-E3 and thus increases accuracy and reliability of the HDA corrosion rate results.

A third measurement portion 103 of the exemplary device cycle shown in FIG. 7 employs detection of spontaneous noise with no external excitation for ECN type measurements, as exemplified in FIGS. 1A-1E above. In one implementation, the system 2 measures sensed current (and/or voltage), filters these using a high-pass or band-pass filter 25, and calculates statistical parameters based on the filtered values, including mean, standard deviation (σ), and rms in certain embodiments, and may compute these statistics from statistical ‘moments’ of the data. Where used, the voltage or potential noise is measured between the reference electrode E2 and circuit ground, where the auxiliary and working electrodes E1 and E3 are effectively connected by the switching system 34c to a virtual ground. The statistical moments themselves may be computed from a complete data set (e.g., many samples of voltages and currents measured over a period of time), but such an approach would involve extensive computational overhead in the processor 22 and high memory usage. In preferred embodiments, a ‘running moment’ approach is employed so as to require significantly less memory. In the illustrated implementation, the processor 22 performs digital filtering and computes the first two statistical moments of the noise data for both current and voltage or for current alone, from which the statistics for mean, standard deviation, and rms are calculated, and used in the on-line electrochemical noise (ECN) measurements. The ECN is advantageously employed in the device 2 for computing a noise index or localized corrosion index value 27, wherein any form of such localized corrosion index 27 may be computed in the device 2 which is indicative of the propensity of the electrodes 8 to localized corrosion attack in a given electrolyte. In one embodiment, a dimensionless localized corrosion value 27 is computed by removing low frequency components, computing the standard deviation, and then scaling the standard deviation σ as described above, which, when exceeding a certain level, indicates the possibility of localized corrosion attack occurring in a given installation.

Current noise is sampled in the device 2 via the working electrode E3 and a weighted average or running moment is computed, with the current noise statistics being used to compute the localized corrosion value 27. In one embodiment, moreover, the voltage (potential) noise may likewise be measured using the voltage sensing circuitry of the probe interface 30 and a second input channel to the A/D 26. In one preferred implementation, the device 2 uses running moment calculations in computing standard deviations σ in deriving the localized corrosion value 27, whereby the system 2 does not need to store large amounts of data and the number of required computations in each device cycle is reduced. In one implementation, the noise statistics are computed as running moments for each A/D sample and the process repeats until a certain number of samples “n” have been obtained, such as 1000 in one example. In this case, two moment variables M1 and M2 are initialized to zero by the processing system 22, and a variable for n is set to 1. The processor 22 then sets the switching system to the ECN configuration, and the sampled current and voltage measurements are incorporated into running computations to update the moment values at each sample time. The following equations provide for updating the moments with xn being the present current sample value and n being the present sample number (e.g., n ranges from 1 through 1000 in this example):

d=(xn−M1)

M2=M2+(1/n)*(d²(1−(1/n)−M2))

M1=M1+(d/n)

In this implementation, moreover, similar computations are made for voltage samples obtained concurrently with the current samples, where the processing system 22 computes the moving moment values M1 and M2 for the voltage noise as well. Moreover, the above calculations are preferably optimized for execution time and memory use, such as by precalcualting certain common factors like (1−1/n) for each pass, wherein the calculations of M2 and M1 are done in the order indicated above for each sample cycle until the predefined number of readings (e.g., n=1000 or 300) have been obtained for both current and voltage readings. Thereafter, the current statistics may be computed as follows:

Mean=M1

Current standard deviation σᵢ=(M2)^{1/2}

The processor 22 similarly computes like statistics for the voltage noise and then computes the current corrosion noise I_{corrnoise} as:

I_{corrnoise}=((B_{HARM} OR B_{USER})*σᵢ)/(ln(10)*σ_{V})

In another possible embodiment, the processor 22 computes a localized corrosion index value 27 based on a standard deviation σ of sampled current signals where the standard deviation σ is based on the running moment calculation. In this implementation, the voltage signals need not be sensed, and the corresponding voltage noise statistics need not be computed for localized corrosion measurement, thereby reducing the computational and memory storage overhead for the processor 22. In this approach, the moments M1 and M2 are computed for the measured current noise (with no excitation).

The system 2 can also effectively short the auxiliary and working electrodes E1 and E3 by connecting these to a virtual ground of the probe interface system 30 during the ECN measurements. In one embodiment, the processing system selectively reconfigures the switching components U13-U16 as shown in the ECN entry of table 70 in FIG. 4, by which the auxiliary electrode E1 is connected through resistors R54 and R58 and through the “0” state of switch U14 to the inverting input of amplifier U10A providing a virtual ground, and the working electrode E3 is connected through resistor R56 to the virtual ground at the inverting input of U9A, as shown in FIG. 3A during the ECN measurements in the third measurement period 103 while the processor 22 performs the above measurements and calculations.

The system 2 in one embodiment is operable as a stand-alone data acquisition and storage device, which may be loop powered via a 4-20 mA control loop 11 or may be battery powered via battery 13 in FIG. 2B, wherein the battery 13 may be chargeable by solar panels or other means. In this regard, the processing system 22 computes corrosion related values such as R_{S}, corrosion rate, localized corrosion index. etc., as described above, in each of a series of device cycles and stores the computed values in the non-volatile memory 24 (FIG. 2B) for subsequent retrieval by a user via a communications device or using the USB (or micro SD) interface 17. The device 2 is accessed by a user communications device (not shown) through the control loop 11 or by other wired or wireless means to allow downloading of the accumulated corrosion data, for instance, using HART or other suitable communications protocol(s). The device 2, moreover, is operable to store one or more day's worth of computed corrosion related values, such as over 5 days worth of data at long device cycle times in the illustrated embodiment. In this respect, for shorted cycle times, more data could be stored, such as several months or even years worth of data. This feature is advantageous in remote applications where the device 2 may be isolated from a distributed control system, and may operate on battery or solar power independently to acquire corrosion information for several days at a time, which data can then be read from the device 2 in a few minutes and thus stored in an external user communications device for transfer to a spreadsheet or to another system for further evaluation, wherein the battery 11 may be charged by solar panels connected to the device 2 in certain implementations.

The above examples are merely illustrative of several possible embodiments of various aspects of the present disclosure, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (i.e., that is functionally equivalent), even though not structurally equivalent to the disclosed structure which performs the function in the illustrated implementations of the disclosure. In addition, although a particular feature of the disclosure may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

The following is claimed:

1. A corrosion measurement system for measuring or monitoring localized corrosion of a structure exposed to an electrolyte, the system comprising:
a probe interface system with a signal conditioning circuit to interface with a plurality of measurement electrodes situated in the electrolyte, the signal conditioning circuit comprising a sensing circuit operative to sense corrosion-related signals via at least one of the electrodes;
a filter operative to remove low-frequency components from the sensed corrosion-related signals;
a processing system operative to compute a standard deviation value indicative of a presence of localized corrosion on the structure based at least partially on the filtered corrosion-related electrical signals.

2. The corrosion measurement system of claim 1, where the processing system is further operative to scale the standard deviation to provide a localized corrosion value.

3. The corrosion measurement system of claim 2, where the filter removes low-frequency components of about 0.05 Hz or less from the sensed corrosion-related signals.

4. The corrosion measurement system of claim 3, further comprising an analog-to-digital converter operatively coupled to receive sensed corrosion-related electrical signals from the probe interface and to generate a digital representation of the sensed corrosion-related signals.

5. The corrosion measurement system of claim 4, wherein the filter is a digital filter implemented in the processing system.

6. The corrosion measurement system of claim 5, where the filter is a high-pass filter or a band-pass filter.

7. The corrosion measurement system of claim 2, further comprising an analog-to-digital converter operatively coupled to receive sensed corrosion-related electrical signals from the probe interface and to generate a digital representation of the sensed corrosion-related signals.

8. The corrosion measurement system of claim 2, wherein the filter is a digital filter implemented in the processing system.

9. The corrosion measurement system of claim 2, where the filter is a high-pass filter or a band-pass filter.

10. The corrosion measurement system of claim 1, wherein the probe interface further comprises:
an excitation circuit operative to provide excitation signals to the electrolyte via a first one of the electrodes; and
a switching system with a plurality of analog switching components coupled with the excitation circuit and the sensing circuitry, the switching components being operable according to corresponding control signals to selectively interconnect circuit components of the excitation and sensing circuits and the electrodes in a plurality of different configurations.

11. The corrosion measurement system of claim 1, where the filter removes low-frequency components of about 0.05 Hz or less from the sensed corrosion-related signals.

12. The corrosion measurement system of claim 1, further comprising an analog-to-digital converter operatively coupled to receive sensed corrosion-related electrical signals from the probe interface and to generate a digital representation of the sensed corrosion-related signals.

13. The corrosion measurement system of claim 1, wherein the filter is a digital filter implemented in the processing system.

14. The corrosion measurement system of claim 1, where the filter is a high-pass filter or a band-pass filter.

15. The corrosion measurement system of claim 1, where the system is implemented in a field device, the system further comprising a non-volatile memory, the processing system being operable in each of a series of device cycles to compute a localized corrosion value based at least partially on the computed standard deviation value and to store the localized corrosion values in the non-volatile memory for subsequent retrieval by a user.

16. The corrosion measurement system of claim 15, where the field device is battery powered.

17. The corrosion measurement system of claim 15, where the field device is powered by a 4-20 mA loop.

18. A method for measuring or monitoring localized corrosion of a structure exposed to an electrolyte, the method comprising:
sensing an ECN signal in the system;
filtering the sensed ECN signal to remove low frequency components to generate a filtered ECN signal;
computing a standard deviation of the filtered ECN signal; and
scaling the standard deviation to provide a localized corrosion value.

19. The method of claim 18, further comprising storing the localized corrosion value for later retrieval by a user.

20. The method of claim 18, where the sensed ECN signal is filtered using a high-pass filter or a band-pass filter.
